(19) United States
(12) Patent Application Publication
(10) Pub. No.: US 2026/0360807 A1
(43) Pub. Date: Nov. 12, 2026

(54) IRON DOPING SOLID ELECTROLYTE FOR SOLID STATE LI-ION BATTERIES

(71) Applicant: Worcester Polytechnic Institute, Worcester, MA (US)

(72) Inventors: Yan Wang, North Andover, MA (US); Jinzhao Fu, Worcester, MA (US)

(21) Appl. No.: 19/569,328

(22) Filed: Mar. 17, 2026

Related U.S. Application Data
(60) Provisional application No. 63/773,192, filed on Mar. 17, 2025.

(51) Int. Cl. H01M 10/0562; H01M 10/0525

(52) U.S. Cl. CPC H01M 10/0562; H01M 10/0525; H01M 2300/008

(57) ABSTRACT

A dopant for a lithium-ion solid-state electrolyte (SSE) is disclosed for improving interfacial stability between halide-based SSEs and lithium-containing anodes. The dopant possesses a reduction potential higher than that of a central metal within the electrolyte framework. Therefore, during battery operation, the dopant is preferentially reduced, forming an interphase layer at the electrolyte-anode interface that suppresses reduction of the host electrolyte framework and mitigates interfacial degradation. The dopant thereby enables direct, stable contact between the halide SSE and the lithium-containing anode, without requiring a separate protective interlayer. In certain implementations, the dopant comprises FeCl₃ incorporated into a Li₃InCl₆-based electrolyte, enabling stable operation with a lithium-indium alloy anode while maintaining the electrolyte's ionic conductivity.

### RELATED APPLICATIONS

This patent application claims the benefit under 35 U.S.C. § 119(e) of U.S. Provisional Patent App. No. 63/773,192, filed Mar. 17, 2025, entitled “IRON DOPING FOR LI-ION BATTERIES,” incorporated herein by reference in entirety.

### BACKGROUND

Lithium-ion batteries (LIBs) have been widely adopted as major power sources for portable electronic devices, electric vehicles (EVs), plug-in hybrid electric vehicles (PHEVs), and large-scale energy storage systems. Despite their widespread use, conventional LIBs with liquid electrolytes pose challenges in safety, energy density, and long-term stability.

All-solid-state lithium batteries (ASSLBs) have been proposed as promising next-generation energy storage systems due to their potential advantages in safety, thermal stability, and energy density. In ASSLBs, solid-state electrolytes (SSEs) replace flammable liquid electrolytes, thereby reducing leakage and flammability risks. Among various SSE materials, halide-based solid-state electrolytes have attracted increasing attention because they can exhibit relatively high lithium-ion conductivity, favorable electrochemical stability, and improved compatibility with high-voltage cathode materials. However, challenges remain in achieving stable interfacial compatibility between halide solid-state electrolytes and lithium-based anodes, which can significantly affect battery performance and cycling stability.

### SUMMARY

A dopant for a lithium-ion solid-state electrolyte (SSE) mitigates the interfacial instability at an anode, resulting from the reduction reaction between halide-based SSEs and lithium-containing anodes. The dopant has a reduction potential higher than that of the central metal in the SSE. As a result, the dopant is preferentially reduced during the initial electrochemical operation, forming a stable interphase layer at the anode-electrolyte interface. This interphase layer protects the electrolyte framework and mitigates further interfacial degradation of the SSE and the anode. In certain configurations, the dopant may include metal halides, such as FeCl₃, introduced into halide SSEs, such as lithium-indium chloride electrolytes.

The configurations described herein are based, in part, on the observation that all-solid-state lithium batteries (ASSLBs) offer the potential for higher energy density and improved safety compared to conventional lithium-ion batteries using liquid electrolytes. Solid-state electrolytes eliminate flammable liquid components and reduce risks associated with leakage, thermal instability, and mechanical damage. Additionally, ASSLB architecture enables the use of lithium metal or lithium alloy anodes, which provide substantially higher theoretical energy density compared with conventional graphite or carbon-based anodes. Though SSEs and ASSLBs provide these promising advances, their practical utilization and application are still limited by many considerable challenges. Sulfide-based SSEs such as Li₁₀GeP₂S₁₂ (LGPS) and Li₇P₃S₁₁ (LPS), though they can provide impressive ionic conductivity that is even comparable to conventional organic liquid electrolytes, are still challenged by air sensitivity, side reactions with oxide cathodes, and limited electrochemical stability. Oxide-based SSEs, such as Li₇La₃Zr₂O₁₂ (LLZO), can offer greater stability but are hindered by complex processing for anode contact and difficulties in cell manufacturing due to their brittle physical properties. On the other hand, halide-based SSEs represent an emerging class of electrolyte materials that combine relatively high ionic conductivity with improved compatibility with high-voltage cathodes and more favorable mechanical characteristics. Conventional halide SSEs, however, still suffer from the shortcomings of interfacial challenges when paired with lithium metal or lithium-containing anodes. The instability of halide SSEs when paired with lithium metal anodes arises from the chemical incompatibility between the halide SSEs and lithium metal, which can lead to the reduction of the metal halide framework and formation of reaction products such as lithium halides and reduced metal species. Such reactions detrimentally degrade the electrolyte structure, increase interfacial resistance, promote lithium dendrite growth, and eventually lead to a complete failure of the battery's electrochemical process.

Accordingly, configurations herein substantially overcome the shortcomings of conventional SSE approaches by providing a dopant for mitigating mechanical degradation and dendrite formation at the anode. The dopant material has a higher reduction potential than the charge material metal, such that reduction of the dopant forms an interphase layer that prevents reduction of the charge material metal for mitigating electrode degradation. In essence, the dopant replaces a portion of the charge material halide as a sacrificial anode material for reduction ahead of the charge material metal, which forms a protective layer on the anode, rather than degrading the electrode interface as conventional lithium anode redox with halides.

In particular configurations, a method for providing power from a Li-ion battery includes forming a lithium-based solid-state electrolyte material including a charge material metal, and adding a dopant having a reduction potential greater than the charge material metal. The solid-state electrolyte material is disposed between a pair of opposed electrodes to reduce the dopant prior to reducing the charge material metal, thereby forming an interface layer that mitigates degradation of the charge material metal in contact with the electrodes. Reduction of the dopant forms an interphase layer at the interface that prevents reduction of the charge material metal for mitigating electrode degradation.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context diagram of a Li-ion cell suitable for use with configurations herein;

FIGS. 2A-2B are schematic diagrams of the interface or interphase layer in the configuration of FIG. 1;

FIGS. 3A-3B display the difference in charge density between Fe-LIC (FIG. 3B) and LIC; and

FIGS. 4A-4D show validation results of various Fe dopant concentrations.

### DETAILED DESCRIPTION

Due to their superior energy density, rechargeability, and durability, lithium-ion batteries (LIBs) support a wide range of applications, including portable electronics, electric vehicles (EVs), and large-scale energy storage solutions. As the power demands from these devices continue to increase, the improvements on LIBs will continue to play a crucial role in pushing the boundaries of modern technologies and sustainability.

SSEs are particularly beneficial for an amenability with lithium metal anodes. However, a fundamental incompatibility of Li anodes with halide SSEs hinders widespread deployment. The instability of halide SSEs when paired with lithium metal anodes arises from the chemical incompatibility between the halide SSEs and lithium metal, which can lead to the reduction of the metal halide framework and formation of reaction products such as lithium halides and reduced metal species, the formation of interfacial reaction products, usually in the form of Li halides and other intermediate products of central metal element halides. Such reactions detrimentally degrade the electrolyte structure, increase interfacial resistance, promote lithium dendrite growth, and eventually lead to a complete failure of the battery's electrochemical process. Furthermore, the electrochemical instability of halide SSEs in contact with lithium metal under operational voltages results in the reduction of the central transition metal and, thereby, the decomposition of the electrolyte. Moreover, the physical instability at the interface, characterized by poor contact and mechanical stresses during cycling, exacerbates these challenges, thereby impacting the longevity and safety of batteries that employ halide SSEs and lithium metal anodes. Chemically, a halide is a binary chemical compound, of which one part is a halogen atom and the other part is an element or radical that is less electronegative (or more electropositive) than the halogen, typically to make a fluoride, chloride, bromide, iodide or astatide compound.

Substantial research efforts have focused on addressing the interfacial challenges associated with lithium metal anodes, since the interface stability between the solid-state electrolyte and the lithium-containing anode is a critical factor affecting the performance, safety, and energy density of ASSLBs. A conventional approach involves adding a protective interlayer of Li-stable SSEs, such as LPS, Lithium Phosphorus Oxynitride (LiPON), or LLZO, to establish stable interfaces with Li metal. These interlayers serve as a barrier to prevent direct contact between the SSEs and the Li anode, thereby mitigating the undesired reactions between them. However, incorporating a protective interlayer adds complexity to the cell structure and introduces additional interfaces between different SSEs, which could compromise cell fabrication and performance. Recent research has explored other strategies to address these issues, such as doping and interface engineering. Certain studies have demonstrated that while both Li₃InCl₆ and Li₆PS₅Cl are thermodynamically unstable against lithium, the latter forms a more stable interphase, suggesting that tailored interlayers could enhance interfacial stability. Other studies have explored anion-substitution strategies, such as fluorine doping of Li₃InCl₆, to modify the electronic structure of the electrolyte and suppress undesirable interfacial reactions with lithium metal. While such approaches may improve stability, they can also reduce ionic conductivity or introduce other performance trade-offs. Despite these developments, halide solid-state electrolytes continue to face challenges related to interfacial degradation and instability when paired with lithium-containing anodes. Accordingly, the configurations disclosed herein provide modified halide-based solid-state electrolytes that promote the formation of a stable interfacial layer during electrochemical operation. In particular implementations involving Li3InCl6-based electrolytes, the disclosed modifications facilitate stable interfacial behavior with lithium-containing anodes while maintaining favorable lithium-ion conductivity. As a result, the disclosed electrolyte compositions provide improved interfacial stability and enable long-term cycling of halide solid-state electrolytes in lithium-metal battery systems.

During the initial screening of all halide-based SSE candidates, Indium (In) stands out as a promising central metal element due to its unique balance of ionic transport properties, electrochemical characteristics, and structural tunability. Compared to other trivalent or tetravalent cations such as Y³⁺, Ta⁵⁺, Zr⁴⁺, and Er³⁺, In³⁺ enables the formation of highly conductive frameworks, exemplified by materials such as Li₃InCl₆, which exhibit potential room-temperature Li⁺ conductivities exceeding 2×10⁻³ S/cm [29,34,35]. the In—Cl coordination environment can facilitate lithium-ion migration through the halide lattice, while the structural framework can accommodate a degree of disorder and defect formation that is beneficial for ionic conductivity. Its substitute flexibility also enables fine-tuning of carrier concentration and defect chemistry, which is more constrained in systems with high-valent cations like Ta⁵⁺, Zr⁴⁺. Therefore, the SSE with In as the central metal element can provide structural advantages for property modification, primarily through element-doping strategies. In addition to these, In-centered halide-SSEs are more amenable to aqueous synthesis and exhibit greater moisture tolerance, offering advantages in scalability, processability, and the practical production of ASSLBs. These characteristics conclusively make In-based halide electrolytes highly promising for next-generation all-solid-state lithium batteries, especially when interfacial compatibility, ionic conductivity, and manufacturability are key design criteria.

The configurations described herein address the interfacial instability commonly observed between Li₃InCl₆ solid-state electrolytes and lithium-containing anodes by introducing an iron (Fe) dopant into the electrolyte composition. In particular implementations, Fe-containing species are incorporated into the Li₃InCl₆ lattice to modify the interfacial electrochemical behavior of the electrolyte. The presence of the Fe dopant promotes a controlled reduction interaction at the electrolyte-anode interface during initial electrochemical operation. In this process, Fe3+ species are preferentially reduced in contact with lithium, which suppresses the undesirable reduction of the In3+ within the halide electrolyte. As a result, a stable interphase layer is formed at the interface between the electrolyte and the lithium-containing anode. The formation of this interphase layer improves the compatibility between the Li₃InCl₆-based electrolyte and lithium-containing anodes, such as lithium-indium alloy anodes, while avoiding the need for additional protective interlayers or complex anode surface modifications. Electrochemical characterization demonstrates that incorporation of the Fe dopant enhances interfacial stability while maintaining the favorable lithium-ion conductivity of the Li₃InCl₆ electrolyte framework. Through this compositional modification, the disclosed electrolyte compositions provide improved interfacial behavior in halide-based solid-state electrolyte systems. The resulting materials enable more stable electrochemical operation in their ASSLB and support the development of solid-state battery systems with improved reliability and performance. In addition, the disclosed approach provides insight into strategies for tailoring the interfacial electrochemistry of halide solid-state electrolytes through controlled dopant incorporation.

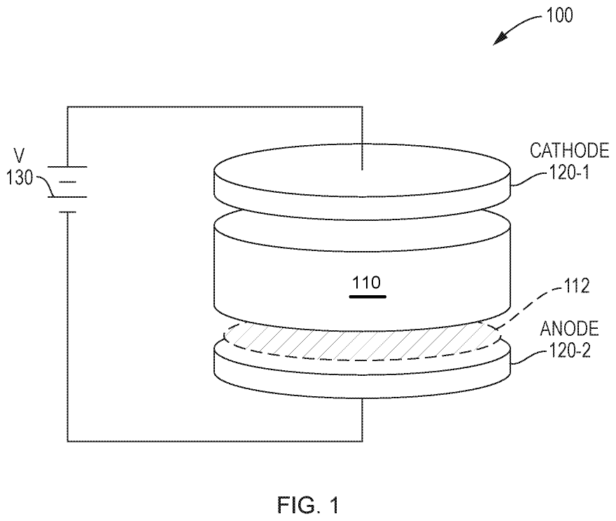

FIG. 1 is a context diagram of a Li-ion cell suitable for use with configurations herein. Referring to FIG. 1, in a lithium-ion battery 100 with a solid-state electrolyte (SSE) 110, the lithium-based solid-state electrolyte material 110 is formed from a charge material metal, to which a dopant is added having a reduction potential greater than the charge material metal. In the example configuration, the dopant should have a reduction potential close to, but slightly above the charge material metal to favor beneficial formation of an interface layer 112, rather than favoring excessive reduction of the charge material metal.

The solid-state electrolyte 110 material is disposed between a pair of opposed electrodes 120-1 . . . 120-2 (designating the cathode and anode, respectively) and connected to a charge source 130 or load. In operation, electron and ionic flow will reduce the dopant prior to the reduction of the charge material metal for forming the interface layer 112 that mitigates degradation of the charge material metal in contact with the electrodes 120.

As indicated above, halide-based SSEs can provide favorable electrochemical performance in batteries employing lithium-containing anodes. However, direct contact between a halide SSE and a lithium metal anode may lead to interfacial instability due to reduction of the metal-halide framework of the electrolyte. The configuration of FIG. 1 depicts an SSE includes a halide, formed by combining the halide of the charge material metal and the dopant, and sintering lithium with the combined halide and dopant. The dopant is selected to have a higher reduction potential than the charge material metal. During battery operation, the dopant is preferentially reduced at the lithium interface, forming an interphase layer at interface 112. This interphase inhibits reduction of the electrolyte framework and stabilizes the electrolyte-anode interface, thereby mitigating interfacial degradation.

In one example configuration, as shown in FIG. 1, the dopant includes FeCl₃, which has a higher reduction potential than indium in the Li₃InCl₆ electrolyte framework. As a result, the Fe species are preferentially reduced during initial electrochemical operation, forming an interphase layer at the electrolyte-anode interface. The interphase layer inhibits the reduction of the indium-containing framework of the electrolyte and thereby mitigates interfacial degradation. The anode 120 may include a lithium-indium alloy. The presence of indium in the alloy can improve the mechanical stability and ductility of the lithium-containing anode, as a pure lithium metal anode may lead to structural instability within the battery cell 100 during operation.

Pristine (undoped) Li₃InCl₆ (LIC) may be prepared by a solid reaction. LiCl and InCl₃ were mixed in a mortar with a 3:1 M ratio in an argon-filled glovebox (O₂<0.1 ppm, H₂O<0.1 ppm). The mixture was then transferred into a quartz tube and sealed under vacuum. Then, the vacuum-sealed quartz was annealed at 320 °C for 12 h to obtain the pristine LIC. In contrast, the doped Fe-LIC was prepared similarly using FeCl₃ or other suitable compounds as the dopant source and was mixed with LiCl and InCl₃. FeCl₃ replaces a portion of the InCl₃ in the mixture to maintain a molar ratio of 3:1 between Li and central metal elements, forming a compound with the desired element composition. Since the melting point of FeCl₃ is 307.6 °C and its boiling point is 315 °C, the Fe-doped sample was later sintered at 310. °C for 12 h to obtain the Li₃FeₓIn₁₋ₓCl₆.

To measure the conductivity of synthesized SSEs, 130 mg of powder was first filled into the split cell and formed into an SSE pellet under two metric tons (173 MPa). After forming the pellet, 5 mg of C65 was spread onto both sides of the pellet as a blocking electrode. The conductivity of the synthesized samples may be calculated through the following equation:

$$σ = \frac{l}{s} \cdot \frac{1}{{R}_{ion}}$$

where σ represents the conductivity of the measured sample, I and s are the thickness (in cm) and electrode contact surface area (in cm²) of the tested pellet. Rᵢₒₙ is the ionic resistance (in ohms) from an Electrochemical Impedance Spectroscopy (EIS) fitting result.

To form the structure of FIG. 1, instead of utilizing pure Li metal during the tests, the interface stability of pristine LIC and Fe-LIC was tested with a Li—In/SSE/Li-In symmetric cell. The Li—In alloy is harder than pure Li and could provide favorable mechanical strength for the cycling test with the symmetric cell. To prepare the symmetric cell, 200 mg of SSE powder was loaded into a pressure-controllable split cell, and the SSE pellet was formed under two metric tons of pressure (173 MPa). The Li/In alloy electrodes were prepared by pressing one piece of lithium chip (12 mm in diameter, ~105 μm in thickness) with one piece of indium chip (12 mm in diameter, ~110 μm in thickness) under 500 kg force (43 MPa). Then, a 10 mm Li/In alloy electrode was cut out from the pressed metal. One piece of Li/In alloy electrode (10 mm in diameter, 210 μm in thickness) was applied on each pellet side to form the symmetric cell. The Li molar percentage in the Li—In alloy electrode is calculated based on the utilized metal weight, which is ~0.00634 g Li vs. ~0.0910 g In, which resulted in a molar ratio of ~54% Li inside the alloy anode. The cell was later cycled with a Land battery test system (3001 A) under a current density from 0.01 mA·cm⁻² to 0.5 mA·cm⁻². Each charge and discharge cycle took 1 h, and the cell was cycled until the interface polarization was unstable.

Based on the principal understanding of the failure mechanism of pristine Li₃InCl₆, an in-situ formed protective layer is an ideal solution to kinetically impede the further reduction reaction. A dopant with a similar reduction potential is required to form a protective interface simultaneously, as Indium (In) is reduced. Therefore, the dopant selection process began with the calculation of the reduction potentials of different dopants. Table I shows the reduction reaction potential of Li₃InCl₆ and Li₃FeCl₆, and presents the calculation results for Fe³⁺; other Li—X—Cl elements may be provided. Based on the results, Fe³⁺ exhibited a standard reduction potential of 3.5 V, which is slightly higher than that of In, 3.46 V. Other than that, Fe ions can form a stable Li—X—Cl type compound with a similar layered structure as LIC, which further reduces the complexity of SSE synthesis. These results indicate that the Fe³⁺ dopant is expected to be reduced ahead of In and deposited onto the anode surface. Other dopants that may be employed, however, may exhibit different reduction performance than Fe³⁺, considering their availability, chemical stability, and Li—X—Cl compound structure. Conclusively, Fe³⁺ is selected as the dopant to address the interface instability presented above.

TABLE I

| | Reactants | | Products | | Gᵣₓₙ⁰ | n | E |
|---|---|---|---|---|---|---|---|
| In (3 > 0) | Li₃InCl₀ | Li | LiCl | In | −1002.45 | 3 | 3.46 V |
| Coefficient | 1 | 3 | 6 | 1 | | | |
| G_{f}⁰(kJ/mol) | −167.027 | 0 | −194.913 | 0 | | | |
| Fe (3 > 0) | Li₃FeCl₃ | Li | LiCl | Fe | −1014.42 | 3 | 3.50 V |
| Coefficient | 1 | 3 | 6 | 1 | | | |
| G_{f}⁰(kJ/mol) | −155.062 | 0 | −194.913 | 0 | | | |

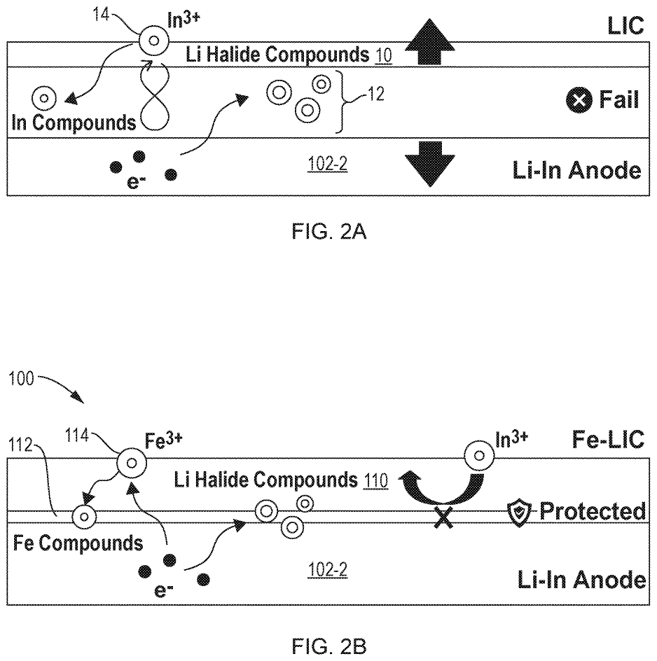

FIGS. 2A-2B are schematic diagrams of the interface layer 112 or interphase layer in the configuration of FIG. 1. Given the determination of Fe as an effective dopant, the interface and the In protection mechanism can be illustrated as in FIGS. 2A and 2B. Referring to FIGS. 1-2B, upon contact with the Li anode 102-2, the central In³⁺ 14 of the undoped LIC 10 would be reduced, producing detrimental LiCl and In chloride compounds 12. The formed solid electrolyte interphase (SEI) layer is electronically conductive, leading to a sustained reduction reaction between the LIC and the Li-anode. Meanwhile, with the Fe³⁺ dopant inside the LIC system 100, its compounds would be reduced ahead of In for its slightly higher reduction potential and then in situ form a protective interface layer 112 that can kinetically impede the further reduction reaction of In. The interface layer 312 therefore reduces the reduction of In³⁺ for avoiding mechanical breakdown of the indium-electrode interface from indium degradation. In the example configuration, the electrodes 102 are formed from a lithium alloy which includes the charge material metal, Li—In in the example as shown. The overall effect is to select the dopant for preventing the formation of lithium halides at the anode 102-2, such that the dopant promotes a redox reaction with the Li. Upon battery operation, this encourages forming the interface layer 112 from the dopant, which prevents further reactions between the SSE and the anode.

Prior to the validation of FIGS. 1 and 2A-2B, computational modeling evaluated the preliminary properties of Fe-doped Li₃InCl₆ (Fe-LIC). In conventional approaches, the Fe chloride compounds and Li—Fe—Cl halide SSEs had raised concerns about their material ionic conductivity. Considering that the ionic conductivity of the doped SSE 110 is one of the primary properties focused on for configurations herein, the effects of Fe-dopant on the Li mobility and ionic conductivity were first simulated to provide preliminary results to assist later synthesis work.

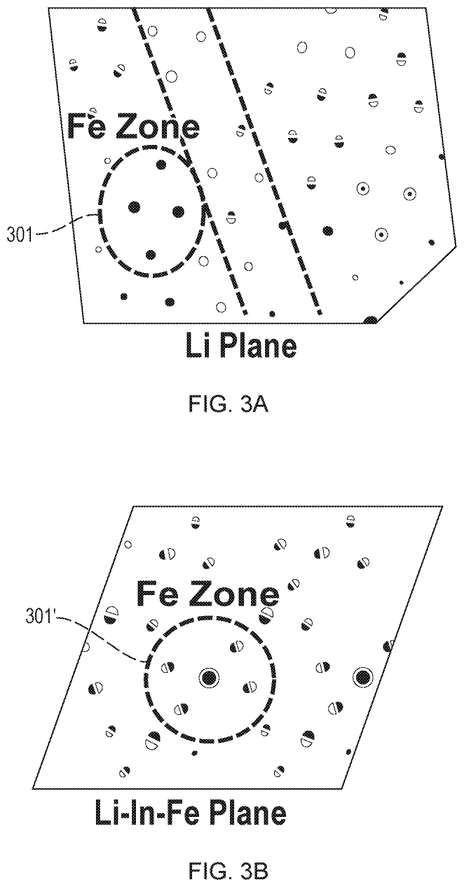

FIGS. 3A-3B display the difference in charge density between Fe-LIC (FIG. 3B) and LIC. These results reveal that Li⁺ ions near the Fe-doped region, as highlighted by a red dashed circle 301, 301′ in FIGS. 3A and 3B, exhibit higher local charge density compared to pristine LIC, indicating stronger coulombic binding and enhanced electrochemical stabilization to the surrounding Cl-coordination environment. Also, as evidenced in FIG. 3B, the further polarization of Li⁺ toward the Fe dopant implies that migration from these sites requires overcoming stronger ionic interactions, thereby increasing the activation energy for diffusion.

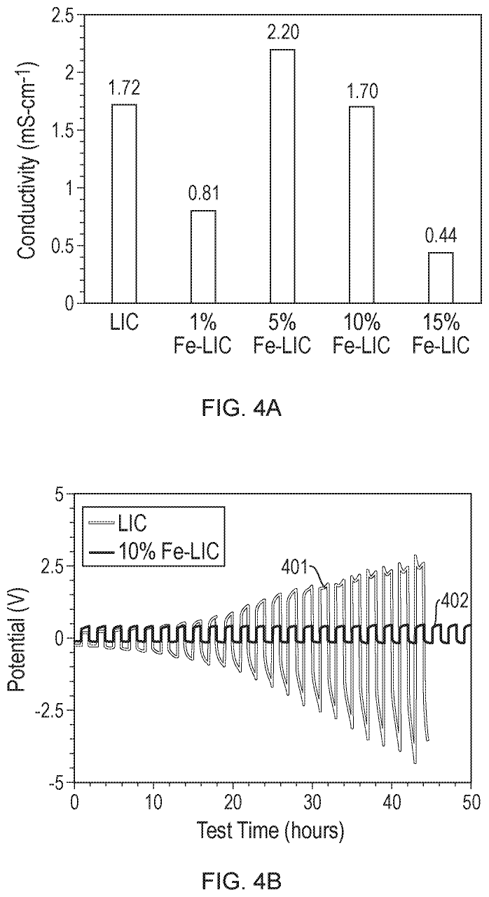

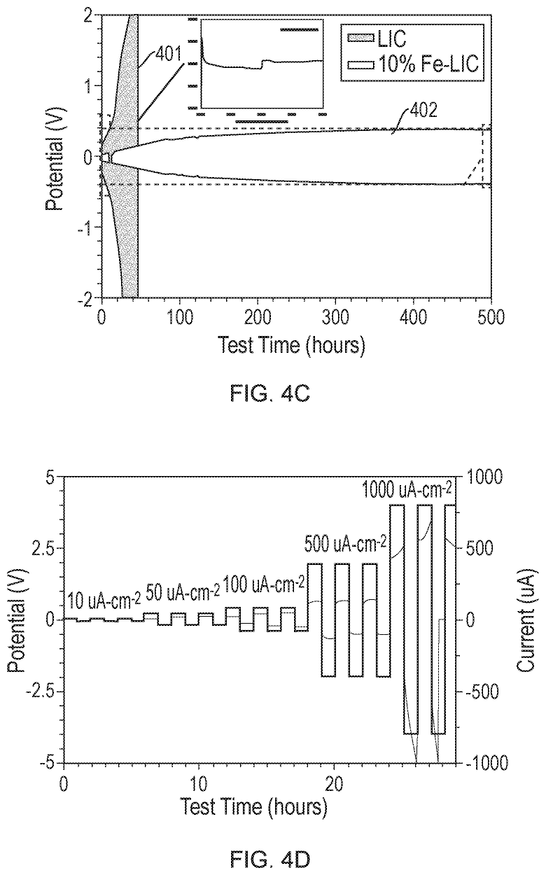

FIGS. 4A-4D show validation results of various Fe dopant concentrations. Samples were evaluated using the ionic conductivity of the electrochemical impedance spectroscopy (EIS). FIG. 4A shows the conductivity of the SSEs with different Fe dopant amounts. FIG. 4B shows a symmetric cell cycling comparison between pristine LIC 401 and 10% Fe-LIC 402, and FIG. 4C shows long symmetric cell cycling of 10% Fe-LIC.

Collectively, FIGS. 4B and 4C illustrate the voltage profile of the Li—In/10% Fe—LIC/Li—In symmetric cell cycled at a 10 uA·cm⁻² current density. By utilizing Li—In alloy, higher static pressure could be applied during the test due to the high yield strength of Li—In alloy. The 10% Fe-LIC sample demonstrated a significantly enhanced interface stability compared to pristine LIC, as demonstrated by lower interface potential and minimal potential increase during cycling. The reduction of central ions disrupts the LIC/Li—In alloy interface, resulting in rapid interface instability and a marked increase in potential, just as the pristine LIC sample exhibited in FIG. 4B. As anticipated, Fe ions can be reduced ahead of In and deposited at the interface, enhancing interfacial entropy and mitigating the reduction reaction. Additionally, the reduced Fe, being electrochemically inactive during battery reactions, kinetically suppresses the reduction reaction.

FIG. 4D depicts the cell critical current density evaluation of the 10% Fe-LIC. Based on the above observations, the critical current density of the formed interface was examined to establish the current cycle rate for subsequent full-cell performance tests. As shown in FIG. 4D, the interface exhibited a stable interface potential with a current density of up to 500 uA·cm⁻² (0.5 mA·cm⁻²). Though a better interface stability was achieved with the Fe-LIC, the observed interfacial polarization limited the current rate selection for the full-cell operation.

The approach above discloses a novel strategy to address interfacial instability between the halide solid-state electrolytes, such as Li₃InCl₆ and Li—In alloy anodes, through Fe doping. Fe was identified as an ideal dopant due to its favorable reduction potential and structural compatibility with the LIC framework through a combination of thermodynamic calculations, atomistic modeling, and comprehensive experimental validation; alternative doping elements for promoting the interphase layer may be provided. The optimized 10 at. % Fe-doped LIC (10% Fe-LIC) demonstrates excellent phase purity, uniform dopant distribution, and preserved ionic conductivity. Notably, this work represents a distinctive, stable, long-term cycling in a LIC-based cell without any protective interlayer, achieving a symmetric cell operation over 200 h and the full-cell operation over 300 cycles with 80% capacity retention.

Configurations herein establish Fe doping as a practical approach to directly stabilize halide SSEs against lithium metal, simplifying cell design while maintaining high electrochemical performance. The doping method disclosed above is achievable by simple solid reactions and is applicable to other SSEs. Its simplification of battery structure by eliminating the need for an interlayer further paves the way for a more practical ASSLB design. The achieved performance with 10% Fe—LIC demonstrates a beneficial dopant strategy towards the mechanical properties of the doped materials, and the establishment of an advanced function mechanism of the Fe dopants in future configurations.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A method for providing power from a Li-ion battery, comprising:
providing a halide-based solid-state electrolyte material having a center metal element;
adding a dopant having a reduction potential greater than the center metal element;
disposing the solid-state electrolyte material between a pair of opposed electrodes; and
reducing the dopant prior to reduction of the center metal element for forming an interface layer that mitigates degradation of the solid electrolyte material in contact with the electrodes.

2. The method of claim 1 wherein the center metal element of the halide-based solid electrolyte is indium and the dopant is an iron compound, the iron in the iron compound having a higher reduction potential than the indium, the iron compound responsive to electrons at the anode for forming the interface layer.

3. The method of claim 1 wherein the interface layer reduces the reduction of In³⁺ for avoiding mechanical breakdown of the indium-electrode interface from indium degradation.

4. The method of claim 1 further comprises selecting the dopant for forming the stable interlayer, which reduced the further reduction reaction.

5. The method of claim 1 further comprises forming the interface layer from the dopant, the interface layer preventing reactions between the SSE and the anode.

6. The method of claim 1 wherein the dopant promotes a reduction reaction with the Li.

7. The method of claim 1 wherein the SSE includes a halide.

8. The method of claim 1 further comprising:
combining a halide solid-state electrolyte with the dopant; and
forming the solid-state electrolyte (SSE) from sintering lithium with the combined halide and dopant.

9. The method of claim 1 wherein the dopant is FeCl₃ and sintering includes heating between a melting point and a boiling point of the dopant.

10. In a lithium ion battery with a solid-state electrolyte (SSE), a method of preventing anode degradation, comprising adding a dopant to the SSE, the dopant having a higher reduction potential than the center metal element in the SSE, reduction of the dopant forming an interphase layer that prevents reduction of the charge material metal for mitigating electrode degradation.

11. A lithium-ion battery, comprising:
an opposed pair of electrodes including a cathode and an anode;
a solid-state electrolyte (SSE) between the electrodes, the SSE including lithium, indium, chloride and a dopant,
the electrodes formed from an alloy including lithium and indium,
the dopant having a higher reduction potential than the indium, the dopant forming an interphase layer at the anode resulting from reduction, the interphase layer preventing anode degradation caused by indium reduction.

12. The battery of claim 11, wherein the SSE is Li₃InCl₆ and the dopant is FeCl₃.
